(19) United States
(12) Patent Application Publication
(10) Pub. No.: US 2009/0233113 A1
(43) Pub. Date: Sep. 17, 2009

(54) ALUMINUM MEMBER OR ALUMINUM ALLOY MEMBER WITH EXCELLENT CORROSION RESISTANCE

(75) Inventors: Jun Hisamoto, Hyogo (JP); Koji Wada, Hyogo (JP); Takayuki Tsubota, Hyogo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko (Kobe Steel Ltd.), Kobe-shi, Hyogo (JP)

(21) Appl. No.: 12/090,552

(22) PCT Filed: Nov. 13, 2006
(86) PCT No.: PCT/JP2006/322586

§ 371 Date: Apr. 17, 2008

(30) Foreign Application Priority Data
Nov. 17, 2005 (JP) 2005-333281
Sep. 6, 2006 (JP) 2006-241933

(51) Int. Cl. B32B 15/04

(52) U.S. Cl. 428/472.2

(57) ABSTRACT

To provide an aluminum alloy or aluminum member having an anodic oxide coating formed thereon, the coating having excellent resistance to gaseous corrosion and resistance to plasma and excellent adhesion, and a member for a vacuum apparatus formed of such an aluminum alloy or aluminum member having excellent corrosion resistance. Moreover, a member having a sufficient voltage resistance is provided to stably keep a plasma state in a process using plasma.

The object is substantialized by providing the following:
(1) An aluminum alloy or aluminum member, wherein the anodic oxide coating has impedance of at least 10⁷Ω at a frequency of 10⁻² Hz, and hardness of at least 400 in Vickers hardness (Hv); or
(2) An aluminum alloy or aluminum member, wherein the anodic oxide coating has impedance of at least 10⁸Ω at a frequency of 10⁻² Hz, and hardness of at least 350 in Vickers hardness (Hv).

### TECHNICAL FIELD

The present invention relates to an aluminum alloy material or an aluminum material having excellent gaseous-corrosion resistance and plasma-corrosion resistance, and particularly relates to an aluminum alloy member (aluminum alloy material or aluminum material) suitable for a material of apparatus using gas or plasma containing a corrosive component or element such as apparatus of manufacturing electronic products or instruments of semiconductor or liquid crystal devices or the like, and relates to a vacuum vessel (vacuum chamber) or a reactor vessel (reactor chamber), or a component set in the vessel, the vessel or the component being formed of the member.

### BACKGROUND ART

Corrosion resistance to corrosive gas (hereinafter, called resistance to gaseous corrosion) is required for a vacuum chamber or reactor chamber (hereinafter, chamber), because corrosive gas containing a halogen element such as Cl, F or Br is introduced to the inside of the chamber as reaction gas, etching gas, or cleaning gas. Moreover, in the chambers, since halogenous plasma is often generated in addition to the corrosive gas, corrosion resistance against plasma (hereinafter, called resistance to plasma) is regarded as important. For application as above, a vacuum chamber or reaction chamber made of aluminum or an aluminum alloy, which is lightweight and excellent in heat conductivity, has been used. Furthermore, the aluminum or aluminum alloy is now extensively used for the component set in the chamber.

However, since the aluminum or aluminum alloy does not have sufficient resistance to gaseous corrosion and resistance to plasma, various surface modification techniques have been proposed to improve properties of those resistance.

As the techniques for improving the resistance to gaseous corrosion and the resistance to plasma, for example, patent literature 1 proposes a technique that an anodic oxide coating in 0.5 to 20 μm is formed, then the coating is subjected to drying by heating at 100 to 150° C. in vacuum so that water content adsorbed in the coating is evaporated and removed. Patent literature 2 proposes a technique that an Al alloy containing copper of 0.05 to 4.0% is subjected to anodizing in an oxalic acid electrolyte, and further dipped in the electrolyte with voltage being dropped.

However, since these anodic oxide coatings are significantly different in corrosion resistance to the gas or plasma depending on quality of the coating, they can not meet the requirement of the corrosion resistance in some use environment of a member for semiconductor manufacturing. Moreover, corrosion may cause unstable electrical properties, and particularly in a process using plasma, the properties can not be kept stable, consequently quality control of products may be obstructed.

On the other hand, in addition to the anodic oxide coating, as coatings having excellent corrosion resistance to the corrosive gas or plasma, coatings of ceramics such as oxides, nitrides, carbonitrides, borides and silicides are given. Examples that the ceramic coatings are directly provided on a surface of an Al alloy by arc ion plating, sputtering, thermal spraying, CVD or the like are found in patent literature 3 and patent literature 4. However, again in the coatings, while they have excellent corrosion resistance to halogen gas or plasma to some extent, they can not sufficiently respond to the requirement of the corrosion resistance to the gas or plasma, which is now strictly evaluated, similarly as the anodic oxide coating.

Furthermore, patent literature 5 and patent literature 6 disclose examples that a ceramic coating is further provided on an anodic oxide coating. However, in this case, there is a particular difficulty in that adhesion between the anodic oxide coating and the ceramic coating is bad. In particular, the members for apparatus of manufacturing the semiconductor or liquid crystal devices are under a severe use environment that the members may be subjected to a number of heat cycles depending on process conditions of manufacturing the semiconductor or liquid crystal devices. Therefore, the members for the apparatus of manufacturing semiconductor or liquid crystal devices are required to have adhesion in a level that separation between the anodic oxide coating and an Al alloy substrate or between the anodic oxide coating and the ceramic coating do not occur even under high-temperature heat cycle or under corrosive environment of gas or plasma.

The patent literature 5 discloses a structure having a boron carbide layer coated on an aluminum base substrate, and an anodic oxide layer formed between the substrate and the boron carbide layer, and proposes a measure of roughing a surface of the anodic oxide coating for improving adhesion of the boron carbide layer to the anodic oxide coating. While boron carbide is a ceramic having excellent resistance to gas corrosion and resistance to plasma, adhesion is bad particularly to the anodic oxide coating and insufficient only by roughing the surface, resulting in cracks or separation, consequently sufficient resistance to gas corrosion or resistance to plasma is not obtained.

The patent literature 6 proposes a measure that 0.1% or more of one or at least two elements selected from C, N, P, F, B and S are contained in the anodic oxide coating in order to improve adhesion between the ceramic coating and the anodic oxide coating. However, it is insufficient in effect of improving the adhesion, and therefore further excellent resistance to gas corrosion or resistance to plasma is required.

[Patent literature 1] JP-B-5-53870

[Patent literature 2] JP-A-3-72098

[Patent literature 3] JP-B-5-53872

[Patent literature 4] JP-B-5-53871

[Patent literature 5] JP-A-10-251871

[Patent literature 6] JP-A-2000-119896

### DISCLOSURE OF INVENTION

### Problems to be Solved by the Invention

It is desirable to provide an aluminum alloy (or aluminum) member having an anodic oxide coating formed thereon, the coating having excellent resistance to gaseous corrosion and resistance to plasma and excellent adhesion, and a vacuum vessel (vacuum chamber), a reactor vessel (reactor chamber), or a component set in the vessel (for example, an electrode, a plate or a component for gas diffusion, a shield of preventing scattering of a substance, a ring for unifying or stabilizing plasma or gas), the vessel or the component being formed of such an aluminum alloy member having excellent corrosion resistance.

It is further desirable to provide a member having sufficient voltage resistance to stably keep a plasma state in a process using plasma.

### Means for Solving the Problems

As a result of earnest study, the inventors propose the following aluminum or aluminum alloy members (Claims 1 to 4).

That is, an embodiment of the invention proposes the following:

(1) an aluminum alloy (or aluminum) member having excellent corrosion resistance, which has an anodic oxide coating formed on a surface thereof, wherein the anodic oxide coating has impedance of at least 107Ω at a frequency of 10⁻² Hz, and hardness of at least 400 in Vickers hardness (Hv);

(2) an aluminum alloy or aluminum member having excellent corrosion resistance, which has an anodic oxide coating formed on a surface thereof, wherein the anodic oxide coating has impedance of at least 10⁸Ω at a frequency of 10⁻² Hz, and hardness of at least 350 in Vickers hardness (Hv);

(3) an aluminum alloy or aluminum member wherein the above anodic oxide coating is formed by using an aqueous solution having a sulfuric acid content of 50 g/l or less (assuming that undiluted solution concentration of the sulfuric acid is 98%) and

(4) a member for a vacuum apparatus formed of the aluminum alloy or aluminum member having excellent corrosion resistance according to (1) to (3).

### ADVANTAGES

According to an embodiment of the invention, the anodic oxide coating formed on the surface of the aluminum alloy or aluminum member is designed to have the impedance of at least 10⁷Ω at the frequency of 10⁻² Hz, and the hardness of at least 400 in Vickers hardness (Hv), or the impedance of at least 10⁸Ω at the frequency of 10⁻² Hz, and the hardness of at least 350 in Vickers hardness (Hv), thereby a coating having excellent resistance to gaseous corrosion and resistance to plasma and excellent adhesion can be formed, and accordingly an aluminum alloy or aluminum member having excellent corrosion resistance as a material for a vacuum chamber used for CVD apparatus, PVD apparatus, and dry etching apparatus can be provided.

Furthermore, the anodic oxide coating having the impedance of at least 10⁸Ω at the frequency of 10⁻² Hz is formed by using the aqueous solution having the sulfuric acid content of 50 g/l or less (assuming that the undiluted solution concentration of the sulfuric acid is 98%), thereby the coating can combine excellent corrosion resistance with excellent voltage resistance.

### BEST MODE FOR CARRYING OUT THE INVENTION

The inventors have conducted study and analysis in various ways on the difficulty of the anodic oxide coating in the related art, and as a result, as clear from examples described later, found that impedance and hardness of the coating and in addition, adhesion of the coating, are importantly dominant factors in a relation to the resistance to gaseous corrosion and the resistance to plasma; and furthermore found that each of values of them is kept within a certain range, thereby the coating can be improved to have excellent resistance to gaseous corrosion and resistance to plasma, in addition, to have excellent adhesion.

For the voltage resistance, the inventors found that an impedance value particularly at low frequency was dominant, and finally the inventors were able to set a value necessary for obtaining stable performance.

Specifically, it is necessary to set the impedance and the hardness of the anodic oxide coating to one of (1) and (2) as follows:

(1) impedance of at least 107Ω at the frequency of 10⁻² Hz, and hardness of at least 400 in Vickers hardness (Hv).

(2) impedance of at least 10⁸Ω at the frequency of 10⁻² Hz, and hardness of at least 350 in Vickers hardness (Hv).

Moreover, to ensure sufficient voltage resistance, the coating essentially has impedance indicated in (2) above, of at least 10⁸Ω at the frequency of 10⁻² Hz, and hardness of at least 350 in Vickers hardness (Hv). More preferably, the coating has impedance of at least 10⁸Ω at the frequency of 10⁻² Hz, and hardness of at least 400 in Vickers hardness (Hv).

In this case, to stabilize quality of the coating, the coating is effectively formed by using the aqueous solution having the sulfuric acid content of 50 g/l or less.

That is, such an anodic oxide coating exhibits a small consumption rate in chloric plasma (BCl₃+Cl₂), and exhibits an excellent property of corrosion resistance in hydrochloric acid (7% HCl solution) (evaluated by time required for hydrogen generation due to corrosion). Furthermore, it has excellent and stable voltage resistance also in practical corrosive environment.

The anodic oxide coating that satisfactorily has the impedance and the hardness can be formed on a surface of an aluminum alloy (or aluminum) member by selecting conditions of anodizing and subsequent hydrolytic treatment (sealing), which can be easily understood by embodiments described later.

Regarding impedance, for example, a mixed solution of sulfuric acid and oxalic acid is used as an electrolyte in the anodizing, and a mixing ratio of the oxalic acid is increased, thereby an impedance value can be increased and adjusted to be at least a lower limit of an embodiment of the invention. The impedance value can be satisfactorily adjusted by increasing temperature or pressure in the hydrolytic treatment as well.

Hardness of the coating can be also increased to be at least a lower limit of the embodiment of the invention by increasing the mixing ratio of the oxalic acid similarly as above. In the hydrolytic treatment, they can be adjusted to be within a range of the embodiment of the invention by controlling temperature in the treatment to be slightly low. Therefore, adjustment of both of the impedance and the hardness into particular range of the embodiment of the invention can be easily carried out and realized by those skilled in the art by considering effects of the conditions on the values, and experimentally confirming the effects as necessary.

For the anodizing solution, sulfuric acid of at least 50 g/l is preferably used, and furthermore a mixed solution of adding oxalic acid of 5 g/l or more, and preferably 10 g/l or more to the sulfuric acid is effectively used. In the present invention, sulfuric acid content (g/l) indicates the content of undiluted solution of the sulfuric acid in 1 l (concentration: 98%).

While voltage can be appropriately changed depending on purposes during electrolysis, the voltage is set to be 10 to 50 V as an initial value, and set to be 30 to 100 V as a final value, thereby advantages of the embodiment of the invention can be improved.

The temperature of the solution is preferably 5° C. or lower particularly in the light of improving plasma resistance (resistance to erosion due to plasma). Moreover, it is preferable that the temperature of the solution is high, at a temperature higher than 10° C., particularly in the light of further improving gas corrosion resistance.

For the voltage resistance, sulfuric acid of at most 50 g/l is preferably used, and furthermore a mixed solution of adding oxalic acid of 10 g/l or more, and preferably 20 g/l or more to the sulfuric acid is effectively used. While voltage can be appropriately changed depending on purposes during electrolysis, the voltage is set to be 20 to 60 V as an initial value, and set to be 30 to 100 V as a final value, thereby the advantages of the embodiment of the invention can be improved. Temperature of the solution is preferably −2 to 25° C., and further effectively within a range of 5 to 18° C.

The preferable range of the temperature of the anodizing solution is different depending on lights of purposes of the solution as above. Therefore, it is obvious that when anodizing is carried out, the temperature is appropriately selected in the light of a purpose required at that time.

For a hydrolytic reaction, water subjected to ion exchange is used. This is to minimize metal ions that may cause malfunction of a semiconductor device and the like. Moreover, as a source of inorganic ions, compounds containing Si are preferably decreased to 15 ppm or less, and more preferably 10 ppm or less.

A treatment method is carried out by dipping an object in the water.

Temperature of the solution is 60° C. or more, and treatment time is 20 min or more. Particularly, to obtain the advantages of the embodiment of the invention, the temperature of the solution is preferably set to be 90° C. or more, and more preferably 95° C. or more. The treatment can be also performed by using a method of exposing an object to pressurized steam in an atmosphere of the steam, which has been generally used, and in this case, it is recommended that pressure is controlled in a range of normal pressure to about twice the normal pressure. Temperature is preferably 90° C. or more as above, however, when pressure is applied in a region beyond the normal pressure, the advantages are exhibited even at 80 to 85° C. or more.

For the voltage resistance, temperature of the solution during hydrolytic reaction is 60° C. or more, and treatment time is 20 min or more, and preferably 30 min or more. Particularly, to obtain the advantages of the embodiment of the invention, the temperature of the solution is preferably set to be 70 to 90° C. The treatment can be also performed by using the method of exposing an object to pressurized steam in an atmosphere of the steam, which has been generally used, and in this case, it is recommended that pressure is controlled in a range of normal pressure to about twice the normal pressure. Temperature is preferably 70 to 90° C. as above, however, when pressure is applied in a region beyond the normal pressure, the advantages are exhibited even at 65 to 85° C.

The advantages of the embodiment of the invention can be achieved by specifically controlling the impedance and the hardness of the anodic oxide coating within the ranges of the conditions, which will be proved by giving specific examples below. However, the present invention is not limited thereto.

### EXAMPLES

### Example 1

Anodizing was carried out at final electrolysis voltage of 30 to 100 V and for treatment time of 20 to 200 min using Al alloy sheets of JIS 6061 or Al alloy sheets of JIS 5052 (50 to 100 mm×50 to 100 mm) as objects, and then hydrolytic treatment (sealing) was carried out, thereby various types of anodic oxide coatings (thickness: 25 to 80 μm) were formed on surfaces of the Al alloy sheets. Impedance (a value of Z at 10⁻² Hz) of the coatings was measured. The impedance was measured in a frequency range of 10⁻³ Hz to 10⁵ Hz, and the value at 10⁻² Hz was selected as an index of stability of the coating. Moreover, hardness of the coatings was measured using a micro-Vickers hardness tester.

Then, aluminum alloy sheets having the anodic oxide coatings formed thereon are irradiated with plasma gas (gas: BCl₃/50%+Cl₂/50% sccm, ICP: 800 to 1000 W, bias: 30 to 120 W, gas pressure: 2 mT, and temperature: 30 to 80° C.) for etching of the coatings, and etching rates at that time were investigated. Furthermore, the aluminum alloy sheets were dipped into HCl (7% aqueous solution), and time required for H₂ foaming was measured.

Table 1 shows detail of formation and treatment conditions of respective anodic oxide coatings, and Table 2 shows measurement results of impedance values, hardness, plasma etching rates, and H₂ foaming time in HCl dipping of the obtained anodic oxide coatings, respectively.

TABLE 1

| | Example of the | Anodizing | | | | | | Hydrolytic Treatment | | | |
|---|---|---|---|---|---|---|---|---|---|---|---|
| | Invention or | | | | | (min) | | | | | (min) |
| | Comparative | | Liquid | | (V) | Treatment | (μm) | | | | Treatment |
| No | Example | Treatment Liquid | Temperature | | Voltage | Time | Thickness | Temperature | | Method | Time |
| 1 | comparative ex | sulfric acid 200 g/l | 5° | C. | 20~40 | 100 | 50 | 90° | C. | dipping | 30 |
| 2 | ex of the | ″ | 12.5° | C. | 20~40 | 100 | 50 | 95° | C. | ″ | 30 |
| | invention | | | | | | | | | | |
| 3 | comparative ex | ″ | 5° | C. | 20~40 | 100 | 50 | 100° | C. | ″ | 30 |
| 4 | ″ | ″ | ″ | | 20~40 | 100 | 50 | 90° | C. | pressuring | 15 |
| | | | | | | | | | | 5 kgf/mm2 | |
| 5 | ″ | sulfric acid 150 g/l | ″ | | 15~25 | 100 | 40 | ″ | | dipping | 30 |
| 6 | ex of the | ″ | 13° | C. | 15~25 | 100 | 40 | ″ | | ″ | 30 |
| | invention | | | | | | | | | | |
| 7 | comparative ex | ″ | 5° | C. | 15~25 | 100 | 40 | 95° | C. | ″ | 30 |
| 8 | ″ | ″ | ″ | | 15~25 | 100 | 40 | 100° | C. | ″ | 30 |
| 9 | ″ | ″ | ″ | | 15~25 | 100 | 40 | 90° | C. | pressuring | 15 |
| | | | | | | | | | | 5 kgf/mm2 | |
| 10 | ex of the | ″ | 13° | C. | 15~25 | 100 | 40 | ″ | | pressuring | 15 |
| | invention | | | | | | | | | 5 kgf/mm2 | |
| 11 | comparative ex | sulfric acid 200 + | 5° | C. | 30~50 | 160 | 60 | ″ | | dipping | 30 |
| | | oxalic acid 5 g/l | | | | | | | | | |
| 12 | ″ | sulfric acid 200 + | ″ | | 30~50 | 160 | 60 | 95° | C. | ″ | 30 |
| | | oxalic acid 5 g/l | | | | | | | | | |
| 13 | ″ | sulfric acid 200 + | ″ | | 30~50 | 160 | 60 | 100° | C. | ″ | 30 |
| | | oxalic acid 5 g/l | | | | | | | | | |
| 14 | ex of the | sulfric acid 200 + | ″ | | 40~50 | 120 | 50 | ″ | | ″ | 40 |
| | invention | oxalic acid 15 g/l | | | | | | | | | |
| 15 | ex of the | sulfric acid 200 + | 11° | C. | 40~50 | 120 | 50 | 90° | C. | ″ | 40 |
| | invention | oxalic acid 15 g/l | | | | | | | | | |
| 16 | ex of the | sulfric acid 200 + | 5° | C. | 50~65 | 120 | 50 | 100° | C. | ″ | 45 |
| | invention | oxalic acid 25 g/l | | | | | | | | | |
| 17 | ex of the | sulfric acid 200 + | 13.5° | C. | 50~65 | 120 | 50 | 95° | C. | ″ | 45 |
| | invention | oxalic acid 25 g/l | | | | | | | | | |
| 18 | comparative ex | sulfric acid 200 + | 5° | C. | 20~30 | 100 | 50 | ″ | | ″ | 40 |
| | | oxalic acid 5 g/l | | | | | | | | | |
| 19 | ex of the | sulfric acid 200 + | ″ | | 20~60 | 150 | 70 | ″ | | ″ | 30 |
| | invention | oxalic acid 10 g/l | | | | | | | | | |
| 20 | ex of the | sulfric acid 150 + | ″ | | 20~60 | 180 | 80 | ″ | | ″ | 40 |
| | invention | oxalic acid 15 g/l | | | | | | | | | |
| 21 | ex of the | sulfric acid 150 + | 13° | C. | 20~60 | 180 | 80 | 90° | C. | ″ | 40 |
| | invention | oxalic acid 15 g/l | | | | | | | | | |
| 22 | ex of the | sulfric acid 150 + | 5° | C. | 30~65 | 150 | 60 | 95° | C. | ″ | 50 |
| | invention | oxalic acid 20 g/l | | | | | | | | | |
| 23 | ex of the | sulfric acid 150 + | ″ | | 30~65 | 150 | 65 | ″ | | ″ | 40 |
| | invention | oxalic acid 25 g/l | | | | | | | | | |
| 24 | ex of the | sulfric acid 150 + | 13° | C. | 30~65 | 150 | 65 | 90° | C. | ″ | 40 |
| | invention | oxalic acid 25 g/l | | | | | | | | | |
| 25 | ex of the | sulfric acid 150 + | 5° | C. | 40~75 | 120 | 70 | 95° | C. | ″ | 40 |
| | invention | oxalic acid 30 g/l | | | | | | | | | |
| 26 | ex of the | sulfric acid 150 + | ″ | | 50~65 | 100 | 30 | 90° | C. | ″ | 60 |
| | invention | oxalic acid 20 g/l | | | | | | | | | |
| 27 | ex of the | sulfric acid 150 + | ″ | | 50~65 | 100 | 30 | 98° | C. | ″ | 30 |
| | invention | oxalic acid 20 g/l | | | | | | | | | |
| 28 | ex of the | sulfric acid 150 + | ″ | | 50~65 | 100 | 30 | 100° | C. | ″ | 50 |
| | invention | oxalic acid 20 g/l | | | | | | | | | |
| 29 | ex of the | sulfric acid 150 + | 13.5° | C. | 50~65 | 100 | 30 | ″ | | ″ | 50 |
| | invention | oxalic acid 20 g/l | | | | | | | | | |
| 30 | ex of the | sulfric acid 150 + | 16° | C. | 50~65 | 100 | 30 | 85° | C. | ″ | 50 |
| | invention | oxalic acid 20 g/l | | | | | | | | | |
| 31 | comparative ex | sulfric acid 30 + | 10° | C. | 40~60 | 160 | 30 | 90° | C. | ″ | 40 |
| | | oxalic acid 20 g/l | | | | | | | | | |
| 32 | ″ | sulfric acid 30 + | ″ | | 40~60 | 160 | 30 | 95° | C. | ″ | 40 |
| | | oxalic acid 20 g/l | | | | | | | | | |
| 33 | ″ | sulfric acid 30 + | ″ | | 35~45 | 160 | 25 | 100° | C. | ″ | 30 |
| | | oxalic acid 20 g/l | | | | | | | | | |
| 34 | ex of the | sulfric acid 30 + | 14.5° | C. | 35~45 | 160 | 25 | 90° | C. | ″ | 30 |
| | invention | oxalic acid 20 g/l | | | | | | | | | |
| 35 | ex of the | sulfric acid 30 + | 15.5° | C. | 35~45 | 160 | 25 | 80° | C. | ″ | 30 |
| | invention | oxalic acid 20 g/l | | | | | | | | | |
| 36 | comparative ex | sulfric acid 30 + | 10° | C. | 35~45 | 160 | 25 | 80° | C. | pressuring | 30 |
| | | oxalic acid 20 g/l | | | | | | | | 5 kgf/mm2 | |
| 37 | ex of the | sulfric acid 30 + | 15.5° | C. | 35~45 | 160 | 25 | 80° | C. | pressuring | 30 |
| | invention | oxalic acid 20 g/l | | | | | | | | 5 kgf/mm2 | |

TABLE 2

| | Example of the | | | | |
|---|---|---|---|---|---|
| | Invention or | Impedance Z | Hardness of | BCl3 + Cl2 plasma | |
| | Comparative | Value at 10⁻² Hz | Coating | etching rate | H2 Foaming Time due to |
| No | Example | (Ω) | (Hv) | (μm) | HCl Dipping (mm) |
| 1 | comparative ex | 9 × 10⁵ | 380 | 0.46 | 3 |
| 2 | ex of the | 4 × 10⁷ | 410 | 0.25 | 40 |
| | invention | | | | |
| 3 | comparative ex | 2 × 10⁷ | 364 | 0.29 | 7 |
| 4 | ″ | 8 × 10⁷ | 380 | 0.26 | 10 |
| 5 | ″ | 1 × 10⁶ | 390 | 0.48 | 3 |
| 6 | ex of the | 2 × 10⁷ | 405 | 0.24 | 35 |
| | invention | | | | |
| 7 | comparative ex | 1 × 10⁷ | 372 | 0.30 | 10 |
| 8 | ″ | 4 × 10⁷ | 370 | 0.24 | 10 |
| 9 | ″ | 2 × 10⁷ | 380 | 0.25 | 7 |
| 10 | ex of the | 7 × 10⁷ | 405 | 0.20 | 45 |
| | invention | | | | |
| 11 | comparative ex | 5 × 10⁶ | 394 | 0.36 | 3 |
| 12 | ″ | 5 × 10⁶ | 380 | 0.30 | 3 |
| 13 | ″ | 4 × 10⁷ | 380 | 0.22 | 10 |
| 14 | ex of the | 4 × 10⁷ | 410 | 0.15 | 15 |
| | invention | | | | |
| 15 | ex of the | 2 × 10⁸ | 405 | 0.15 | 30 |
| | invention | | | | |
| 16 | ex of the | 2 × 10⁷ | 405 | 0.18 | 12 |
| | invention | | | | |
| 17 | ex of the | 3 × 10⁸ | 405 | 0.15 | 40 |
| | invention | | | | |
| 18 | comparative ex | 2 × 10⁷ | 390 | 0.24 | 15 |
| 19 | ex of the | 1 × 10⁷ | 410 | 0.20 | 15 |
| | invention | | | | |
| 20 | ex of the | 2 × 10⁷ | 415 | 0.19 | 12 |
| | invention | | | | |
| 21 | ex of the | 5 × 10⁷ | 410 | 0.20 | 35 |
| | invention | | | | |
| 22 | ex of the | 3 × 10⁷ | 415 | 0.12 | 12 |
| | invention | | | | |
| 23 | ex of the | 4 × 10⁷ | 410 | 0.19 | 15 |
| | invention | | | | |
| 24 | ex of the | 2 × 10⁸ | 405 | 0.20 | 40 |
| | invention | | | | |
| 25 | ex of the | 2 × 10⁷ | 410 | 0.22 | 15 |
| | invention | | | | |
| 26 | ex of the | 1 × 10⁷ | 415 | 0.25 | 15 |
| | invention | | | | |
| 27 | ex of the | 3 × 10⁷ | 410 | 0.15 | 20 |
| | invention | | | | |
| 28 | ex of the | 4 × 10⁷ | 410 | 0.12 | 20 |
| | invention | | | | |
| 29 | ex of the | 7 × 10⁷ | 400 | 0.16 | 40 |
| | invention | | | | |
| 30 | ex of the | 2 × 10⁸ | 400 | 0.16 | 50 |
| | invention | | | | |
| 31 | comparative ex | 2 × 10⁶ | 390 | 0.37 | 10 |
| 32 | ″ | 8 × 10⁶ | 380 | 0.30 | 10 |
| 33 | ″ | 1 × 10⁷ | 380 | 0.28 | 7 |
| 34 | ex of the | 7 × 10⁷ | 405 | 0.22 | 30 |
| | invention | | | | |
| 35 | ex of the | 5 × 10⁷ | 400 | 0.25 | 45 |
| | invention | | | | |
| 36 | comparative ex | 6 × 10⁷ | 360 | 0.35 | 7 |
| 37 | ex of the | 2 × 10⁸ | 380 | 0.22 | 30 |
| | invention | | | | |

Table 2 shows that Nos. 2, 6, 10, 14 to 17, 19 to 30, 34, 35, 37 included in the scope of the present invention, that is, in the case that the impedance value at the frequency of 10 2 Hz of the anodic oxide coating is 10⁷Ω or more, and the hardness of the coating is 400 or more (Hv), the plasma etching rate is 0.25 μm or less, and the H₂ foaming time in HCl dipping is 12 min or more, excellent results have been obtained. On the other hand, nos. 3, 4, 5, 7 to 9, 11 to 13, 18, 31 to 33, 36 corresponding to comparative examples not satisfying these conditions together show deterioration in resistance to gaseous corrosion and resistance to plasma.

### Example 2

Anodizing was carried out at final electrolysis voltage of 30 to 60 V and for treatment time of 60 to 200 min using Al alloy sheets of JIS 6061 or Al alloy sheets of JIS 5052 (50 to 100 mm×50 to 100 mm) as objects, and then hydrolytic treatment (sealing) was carried out, thereby various types of anodic oxide coatings (thickness: 10 to 60 μm) were formed on surfaces of the Al alloy sheets. Impedance (a value of Z at 10⁻² Hz) of the coatings was measured. The impedance was measured in a frequency range of 10⁻³ Hz to 10⁵ Hz, and the value at 10⁻² Hz was selected as an index of stability of the coating. Moreover, hardness of the coatings was measured using a micro-Vickers hardness tester.

The aluminum alloy sheets were dipped into HCl (7% aqueous solution), and time required for H₂ foaming was measured. Furthermore, dielectric breakdown voltage of the coatings was measured using a DC power supply.

Table 3 shows detail of formation and treatment conditions of respective anodic oxide coatings, and Table 4 shows measurement results of impedance values, hardness, H₂ foaming time in HCl dipping, and withstanding voltage (dielectric breakdown voltage) of the obtained anodic oxide coatings, respectively.

TABLE 3

| | Example of the | Anodizing | | | | | | Hydrolytic Treatment | | | |
|---|---|---|---|---|---|---|---|---|---|---|---|
| | Invention or | | | | | (min) | | | | | (min) |
| | Comparative | | Liquid | | (V) | Treatment | (mm) | | | | Treatment |
| No | Example | Treatment Liquid | Temperature | | Voltage | Time | Thickness | Temperature | | Method | Time |
| 1 | comparative | sulfric acid 200 g/l | 5° | C. | 20~40 | 100 | 50 | 90° | C. | dipping | 30 |
| | example | | | | | | | | | | |
| 2 | comparative | ″ | ″ | | 20~40 | 100 | 50 | 100° | C. | ″ | 30 |
| | example | | | | | | | | | | |
| 3 | comparative | ″ | ″ | | 20~40 | 100 | 50 | 90° | C. | pressuring | 15 |
| | example | | | | | | | | | 5 kgf/mm2 | |
| 4 | comparative | sulfric acid 150 g/l | ″ | | 15~25 | 100 | 40 | ″ | | dipping | 30 |
| | example | | | | | | | | | | |
| 5 | comparative | ″ | ″ | | 15~25 | 100 | 40 | 95° | C. | ″ | 30 |
| | example | | | | | | | | | | |
| 6 | comparative | sulfric acid 200 + | ″ | | 30~50 | 160 | 60 | ″ | | dipping | 30 |
| | example | oxalic acid 5 g/l | | | | | | | | | |
| 7 | comparative | sulfric acid 200 + | ″ | | 30~50 | 160 | 60 | 95° | C. | ″ | 30 |
| | example | oxalic acid 5 g/l | | | | | | | | | |
| 8 | example of the | sulfric acid 2 + | 15° | C. | 40~50 | 200 | 50 | 80° | C. | ″ | 40 |
| | invention | oxalic acid 20 g/l | | | | | | | | | |
| 9 | example of the | sulfric acid 5 + | ″ | | 40~60 | 200 | 50 | ″ | | ″ | 45 |
| | invention | oxalic acid 25 g/l | | | | | | | | | |
| 10 | example of the | sulfric acid 2 + | 10° | C. | 30~40 | 150 | 60 | 85° | C. | ″ | 60 |
| | invention | oxalic acid 30 g/l | | | | | | | | | |
| 11 | example of the | sulfric acid 50 + | ″ | | 30~40 | 120 | 50 | ″ | | ″ | 40 |
| | invention | oxalic acid 30 g/l | | | | | | | | | |
| 12 | example of the | sulfric acid 20 + | ″ | | 20~40 | 120 | 40 | ″ | | ″ | 50 |
| | invention | oxalic acid 20 g/l | | | | | | | | | |
| 13 | example of the | sulfric acid 5 + | 15° | C. | 25~50 | 180 | 45 | ″ | | ″ | 40 |
| | invention | oxalic acid 25 g/l | | | | | | | | | |
| 14 | example of the | sulfric acid 2 + | ″ | | 30~60 | 120 | 50 | 80° | C. | ″ | 60 |
| | invention | oxalic acid 30 g/l | | | | | | | | | |
| 15 | example of the | sulfric acid 2 + | ″ | | 30~60 | 120 | 50 | 90° | C. | ″ | 60 |
| | invention | oxalic acid 30 g/l | | | | | | | | | |
| 16 | example of the | sulfric acid 5 + | ″ | | 25~55 | 90 | 30 | 75° | C. | ″ | 90 |
| | invention | oxalic acid 30 g/l | | | | | | | | | |
| 17 | example of the | sulfric acid 5 + | ″ | | 25~55 | 90 | 30 | 90° | C. | ″ | 30 |
| | invention | oxalic acid 30 g/l | | | | | | | | | |
| 18 | comparative | sulfric acid 60 + | 10° | C. | 20~40 | 70 | 30 | 90° | C. | ″ | 40 |
| | example | oxalic acid 20 g/l | | | | | | | | | |

| | | | | | | | | | | |
|---|---|---|---|---|---|---|---|---|---|---|
| 19 | comparative | sulfric acid 30 + | ″ | 20~40 | 160 | 60 | 90° | C. | ″ | 40 |
| | example | oxalic acid 20 g/l | | | | | | | | |

TABLE 4

| | Example of the | | | | |
|---|---|---|---|---|---|
| | Invention or | | | Voltage Resistance | |
| | Comparative | Impedance Z Value at | Hardness of Coating | Dielectric Breakdown | H2 Foaming Time due to |
| No | Example | 10⁻² Hz (Ω) | (Hv) | Voltage (V/10 μm) | HCl Dipping (min) |
| 1 | comparative | 9 × 10⁵ | 380 | 200 | 3 |
| | example | | | | |
| 2 | comparative | 2 × 10⁷ | 364 | 170 | 7 |
| | example | | | | |
| 3 | comparative | 8 × 10⁷ | 380 | 140 | 10 |
| | example | | | | |
| 4 | comparative | 1 × 10⁶ | 390 | 170 | 3 |
| | example | | | | |
| 5 | comparative | 1 × 10⁷ | 372 | 170 | 10 |
| | example | | | | |
| 6 | comparative | 5 × 10⁶ | 394 | 140 | 3 |
| | example | | | | |
| 7 | comparative | 5 × 10⁶ | 380 | 140 | 3 |
| | example | | | | |
| 8 | example of the | 5 × 10⁸ | 360 | 270 | 150 |
| | invention | | | | |
| 9 | example of the | 3 × 10⁸ | 370 | 240 | 200 |
| | invention | | | | |
| 10 | example of the | 1 × 10⁸ | 390 | 230 | 120 |
| | invention | | | | |
| 11 | example of the | 2 × 10⁸ | 410 | 210 | 90 |
| | invention | | | | |
| 12 | example of the | 1 × 10⁸ | 400 | 210 | 80 |
| | invention | | | | |
| 13 | example of the | 3 × 10⁸ | 380 | 270 | 180 |
| | invention | | | | |
| 14 | example of the | 2 × 10⁸ | 380 | 275 | 180 |
| | invention | | | | |
| 15 | example of the | 1 × 10⁸ | 360 | 270 | 150 |
| | invention | | | | |
| 16 | example of the | 3 × 10⁸ | 370 | 250 | 120 |
| | invention | | | | |
| 17 | example of the | 2 × 10⁸ | 360 | 210 | 90 |
| | invention | | | | |
| 18 | comparative | 8 × 10⁶ | 390 | 180 | 15 |
| | example | | | | |
| 19 | comparative | 5 × 10⁶ | 380 | 185 | 15 |
| | example | | | | |

Table 4 shows that in the case of No. 8 to 17 corresponding to examples of the invention, that is, in the case that the impedance value at the frequency of 10⁻² Hz of the anodic oxide coating is 10⁸Ω or more, and the hardness of the coating is 350 or more (Hv), the H₂ foaming time in HCl dipping is 60 min or more, and the withstanding voltage is 210 V/10 μm or more. Accordingly, it is known that excellent results are obviously obtained in that case compared with the case of No. 1 to 7 and 18 to 19 corresponding to comparative examples that do not satisfy the conditions together.

In this way, the aluminum member or the aluminum alloy member of the embodiment of the invention has the anodic oxide coating formed on the surface of the member, which is excellent in both properties of the resistance to plasma and the resistance to gaseous corrosion, that is, has excellent corrosion resistance, therefore the member can be extremely advantageously used for a material of forming the vacuum vessel (vacuum chamber) used for the vacuum apparatuses such as CVD apparatus, PVD apparatus and dry etching apparatus, reactor vessel (reactor chamber), or component set in the vessel.

1. An aluminum alloy or aluminum member having excellent corrosion resistance, which has an anodic oxide coating formed on a surface thereof,
wherein the anodic oxide coating has impedance of at least 10⁷Ω at a frequency of 10⁻² Hz, and hardness of at least 400 in Vickers hardness.

2. An aluminum alloy or aluminum member having excellent corrosion resistance, which has an anodic oxide coating formed on a surface thereof,
wherein the anodic oxide coating has impedance of at least 10⁸Ω at a frequency of 10⁻² Hz, and hardness of at least 350 in Vickers hardness.

3. The aluminum alloy or aluminum member according to claim 2,
wherein the anodic oxide coating according to claim 2 is formed with an aqueous solution having a sulfuric acid content of 50 g/l or less, assuming that undiluted solution concentration of the sulfuric acid is 98%.

4. A member for a vacuum apparatus, comprising the aluminum alloy or aluminum member according to claim 1.
